(19) United States
(12) Patent Application Publication
(10) Pub. No.: US 2015/0150749 A1
(43) Pub. Date: Jun. 4, 2015

(54) MASSAGE TOOL AND METHODS OF USE

(71) Applicant: Julie Deramo, Bellevue, WA (US)

(72) Inventor: Julie Deramo, Bellevue, WA (US)

(21) Appl. No.: 14/219,659

(22) Filed: Mar. 19, 2014

Related U.S. Application Data
(63) Continuation-in-part of application No. 29/475,585, filed on Dec. 4, 2013, now Pat. No. D712056.

(51) Int. Cl. A61H 7/00

(52) U.S. Cl. CPC A61H 7/003; A61H 2201/0157; A61H 2201/1253

(57) ABSTRACT

A massage tool and methods of using the massage tool are provided.

### CROSS-REFERENCE TO RELATED APPLICATION

This application is a continuation-in-part of design patent application Ser. No. 29/475,585 filed Dec. 4, 2013, which is incorporated by reference herein.

### BACKGROUND

Massage is an ancient art that is used to relax muscles, relieve tension, promote circulation, and generally induce a feeling of well-being. Massage is also used for therapeutic purposes. Many massage therapy techniques involve the therapist applying forceful pressure into the targeted area. This use of forceful pressure may be painful to the person receiving the massage and may cause occupational-related injuries to the therapist.

Thus there exists a need in the art for a massage tool and method that improves circulation without causing discomfort to the recipient of the massage and reduces occupational stress on the therapist. The present disclosure addresses this and other needs.

### SUMMARY OF INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure provides a massage tool comprising a generally oval-shaped concave disc having a top end; a bottom end; a length; a left side; a right side; a plurality of widths; and a depth, wherein the width varies such that the width at, and proximal to, the bottom end is smaller than the width at, and proximal to, the top end.

In one aspect, the present disclosure provides methods of using the massage tool of the present disclosure.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a perspective front view of the massage tool of the present disclosure.

FIG. 2 illustrates a perspective back view of the massage tool of FIG. 1.

FIG. 3 illustrates a side elevational view of the massage tool of FIG. 1.

FIG. 4 illustrates a cross sectional view taken through 4-4 of the massage tool of FIG. 1.

FIG. 5 illustrates an enlarged sectional piece of the massage tool illustrated in FIG. 4.

FIG. 6 illustrates one embodiment of the massage tool of the present disclosure.

FIG. 7 illustrates one embodiment of the massage tool of the present disclosure.

FIG. 8 illustrates one embodiment of the massage tool of the present disclosure.

FIG. 9 illustrates a massage tool of the present disclosure in the hand of a person practicing the methods of the present disclosure.

### DETAILED DESCRIPTION

In one aspect, the present disclosure provides a massage tool.

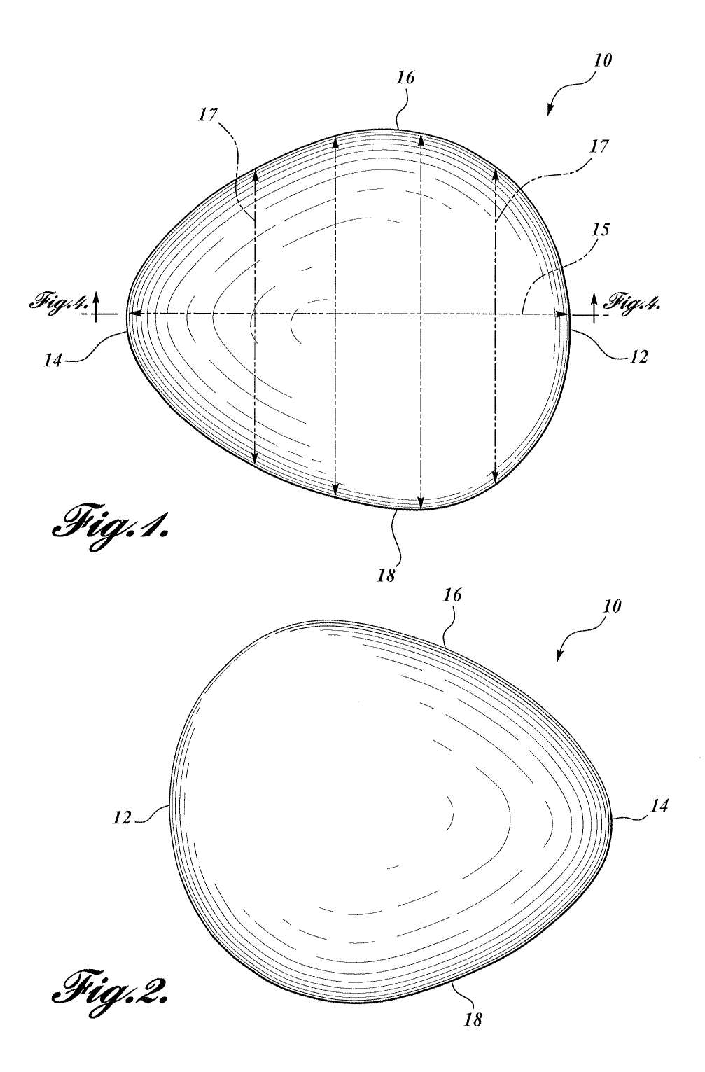

Referring to FIG. 1, the massage tool of the present disclosure comprises a generally oval-shaped concave disc 10 having a top end 12; a bottom end 14; a length 15; a left side 16, a right side 18; and a plurality of widths 17, wherein the width 17 varies such that the width at, and proximal to, the bottom end 14 is smaller than the width at, and proximal to, the top end 12. FIG. 1 illustrates a perspective front view of a massage tool of the present disclosure with the concave side up. FIG. 2 illustrates a perspective rear view of a massage tool of the present disclosure with the convex side up.

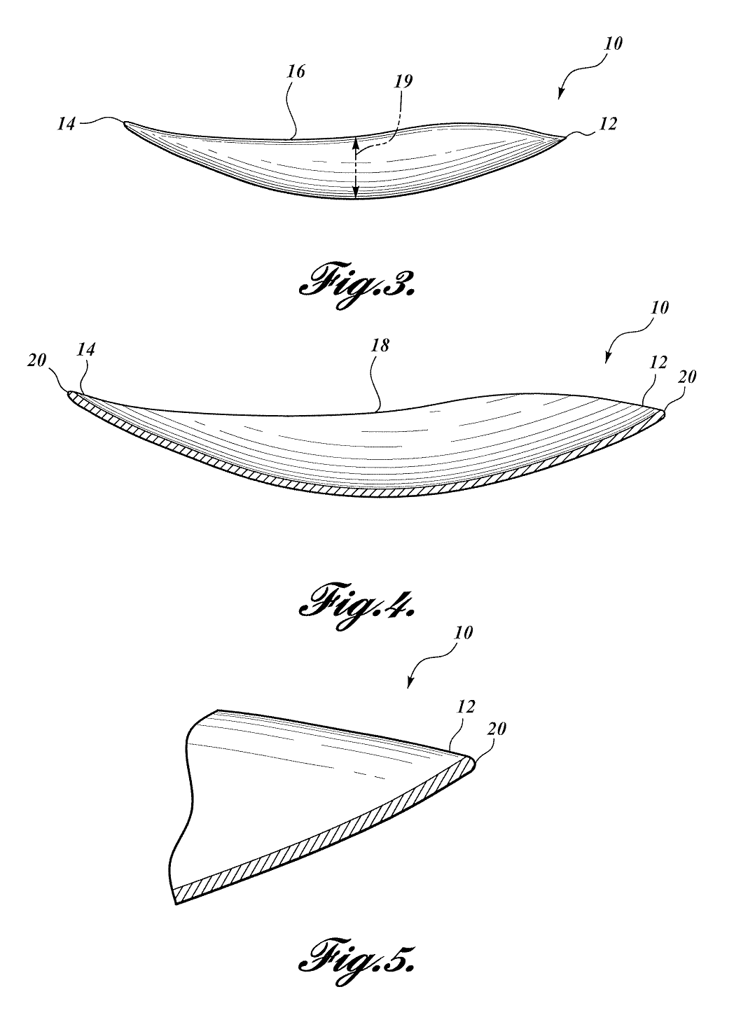

FIG. 3 illustrates a side elevational view of the massage tool of the present disclosure with the concave side up. Referring to FIG. 3, the massage tool of the present disclosure has a depth 19, which is a measurement of the concavity of the disc. The depth can be determined by measuring the vertical distance from the vertex of the disc to a horizontal plane lying across the disc from end to end and contiguous to the disc.

The disc 10 can be of a variety of sizes and depths to accommodate use on various body parts, as well as personal preferences of the user. For example a small size is suitable for use on the face; whereas a larger size is more suitable for use on the thigh. By way of example, but not limited to, in some embodiments, the length 15 of the disc 10 may range from about 5 cm to about 8.5 cm. By way of example, but not limited to, in some embodiments the width 17, at the widest distance between the right side 18 and the left side 16, may range from about 6.5 cm to about 7.5 cm. By way of example, but not limited to, in some embodiments, the depth 19 of the disc 10 may range from about 0.5 cm to about 1.25 cm.

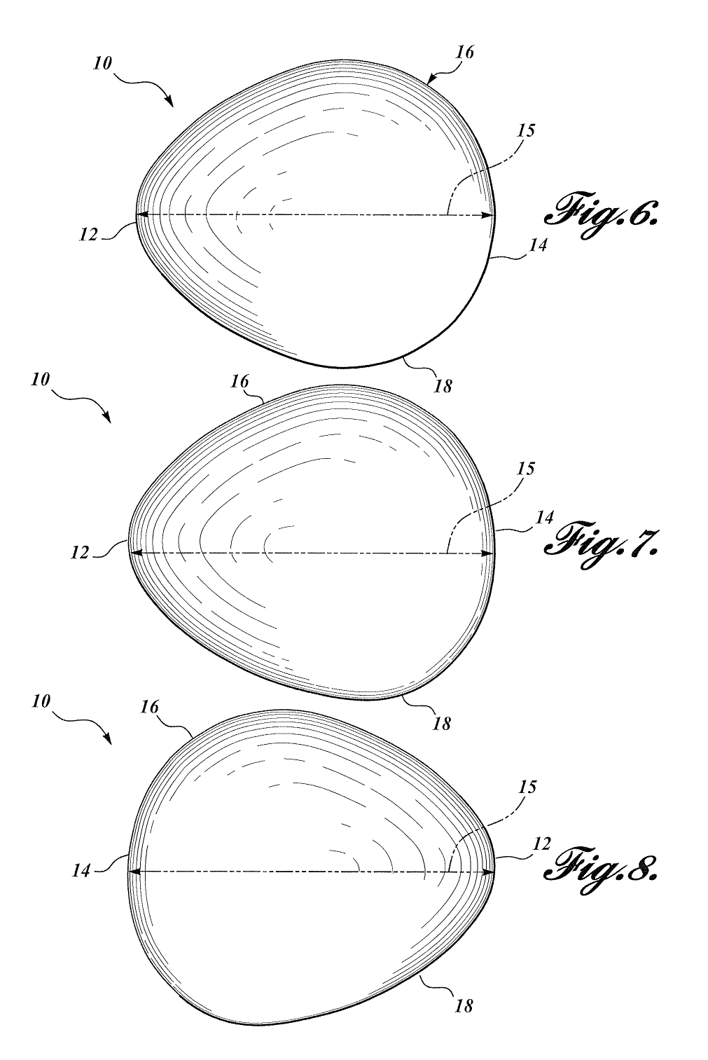

The thickness of the disc 10 ranges from about one mm to about three mm. The thickness of the disc 10 is substantially the same throughout. FIG. 4 illustrates a cross-section view through 4-4 of FIG. 1. Referring to FIG. 4, the hash marks indicate the interior of the massage tool. The surfaces of the disc 10 are smooth. The edges 20 around the perimeter of the disc 10 are smooth, and beveled, so as not to cause injury to the user or person receiving the massage. FIG. 5 is an enlargement of a section illustrated in FIG. 4. As illustrated in FIG. 5, the edges 20 are smooth and beveled. FIG. 4 and FIG. 5 are for illustrative purposes only and are not drawn to scale.

The disc 10 may be constructed of a variety of materials. In some embodiments, the material is a metal. In some embodiments, the material is copper. The disc 10 may be constructed by techniques well known in the art.

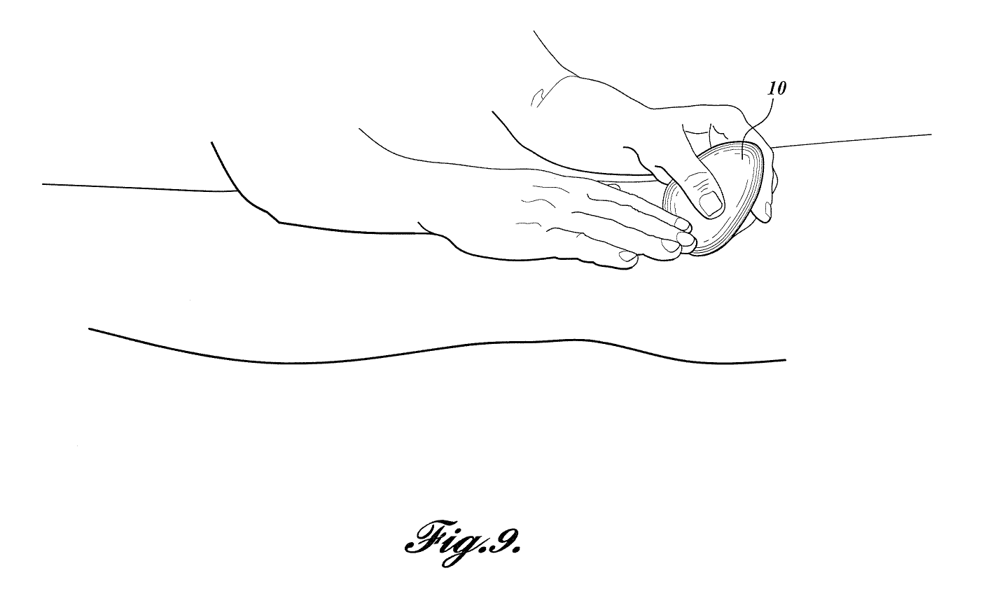

Referring to FIGS. 6 to 8, the disc 10 may be of different shapes. As shown in FIG. 6, in some embodiments, the disc 10 is generally symmetrical about an axis along the length 15 of the disc 10. As shown in FIG. 7 and in FIG. 8, in some embodiments, the disc 10 is asymmetrical about an axis along the length 15 of the disc 10. As shown in FIG. 7, in some embodiments, the left side 16 of the disc 10 has more curvature than the right side 18 of the disc 10, which is relatively straight. This embodiment may be more suitable for left-handed users. As shown in FIG. 8, in some embodiments, the right side 18 of the disc has more curvature than the left side 16 of the disc, which is relatively straight. This embodiment may be more suitable for right-handed users.

In one aspect, the present disclosure provides a method of performing massage comprising: (a) providing a massage tool comprising a generally oval-shaped concave disc 10 having a top end 12; a bottom end 14; a length 15; a left side 16, a right side 18; a plurality of widths 17; and a depth 19, wherein the width 17 varies such that the width at, and proximal to, the bottom end is smaller than the width at, and proximal to, the top end; (b) grasping the massage tool; (c) placing the massage tool in contact with body tissue; and (d) repeatedly gently stroking the body tissue to promote circulation to the body tissue.

As used herein, the term “gently” refers to applying a moderate amount of pressure so as to promote circulation without producing discomfort or pain in the person receiving the massage or causing occupational stress to the person performing the massage.

The shape and thinness of the massage tool of the present disclosure aids the therapist in performing effective massage therapy. For example, when using the massage tool of the present disclosure to stroke a part of the body, the therapist may gain feedback on the texture and constitution of the underlying tissue, which aids the therapist in determining the amount of pressure to apply to address the specific condition of the tissue and provide effective massage therapy.

Therefore, the methods of the present disclosure further comprise the steps of: (e) obtaining feedback about the body tissue from using the massage tool in step (d); (f) determining the amount of pressure to apply to the body tissue based on the feedback obtained in step (e); (g) applying the amount of pressure determined in step (f); and (h) repeating steps (d) through (g).

FIG. 9 illustrates a person using a massage tool of the present disclosure in a method of the present disclosure. The direction of stroking may vary, depending on the body part receiving the massage. For example, in one embodiment, if the body part is a limb, for example a leg, as illustrated in FIG. 9, the stroking is done in the direction toward the heart. For example, in one embodiment, if the body part is the abdomen, the stroking is down in a circular clockwise direction.

While not being bound by any theory, the concavity of the disc aids in preventing and relieving ergonomic stress on the user of a massage tool of the present disclosure. As shown in FIG. 9, in practicing a method of the present disclosure, the user of a massage tool of the present disclosure grips the tool with the thumb placed in the concave area of the disc 10. The thumb acts as a fulcrum during the stroking process, leveraging the amount of input force by the user such that the user is required to use less force to achieve the desired result. This feature allows the user to practice the method of the present disclosure for long periods of time, while preventing or relieving ergonomic injury to the wrist, hand, or forearm of the user.

In some embodiments, the method further comprises applying oil to the body tissue. In some embodiments, the method further comprises heating the massage tool.

While the invention has been illustrated and described, it will be appreciated that various changes can be made therein without departing from the spirit and scope of the invention.

I claim:

1. A massage tool comprising: a generally oval-shaped concave disc having a top end; a bottom end; a length; a left side, a right side; a plurality of widths; and a depth; wherein the width varies such that the width at, and proximal to, the bottom end is smaller than the width at, and proximal to, the top end.

2. The massage tool of claim 1, wherein the length of the disc ranges from about 5 cm to about 8.5 cm.

3. The massage tool of claim 1, wherein the maximum width of the disc ranges from about 6.5 cm to about 7.5 cm.

4. The massage tool of claim 1, wherein the depth of the disc ranges from about 0.5 cm to about 1.25 cm.

5. The massage tool of claim 1, wherein the thickness of the disc ranges from about 1 mm to about 3 mm.

6. The massage tool of claim 5, wherein the thickness of the disc is about 1 mm.

7. The massage tool of claim 1, wherein the tool is constructed of a metal.

8. The massage tool of claim 7, wherein the metal is copper.

9. The massage tool of claim 1, wherein the disc is generally symmetrical about an axis along the length of the disc.

10. The massage tool of claim 1, wherein the disc is generally asymmetrical about an axis along the length of the disc.

11. The massage tool of claim 10, wherein the left side of the disc has more curvature than the right side of the disc, and the right side of the disc is relatively straight.

12. The massage tool of claim 10, wherein the right side of the disc has more curvature than the left side of the disc, and the left side of the disc is relatively straight.

13. A method of performing massage comprising:
(a) providing a massage tool comprising a generally oval-shaped concave disc having a top end; a bottom end; a length; a left side, a right side; a plurality of widths; and a depth; wherein the width varies such that the width at, and proximal to, the bottom end is smaller than the width at, and proximal to, the top end;
(b) grasping the massage tool;
(c) placing the massage tool in contact with body tissue; and
(d) repeatedly gently stroking the body tissue to promote circulation to the body tissue.

14. The method of claim 13 further comprising the steps of:
(e) obtaining feedback about the body tissue from using the massage tool in step (d);
(f) determining the amount of pressure to apply to the body tissue based on the feedback obtained in step (e);
(g) applying the amount of pressure determined in step (f); and
(h) repeating steps (d) through (g).

15. The method of claim 13, wherein the stroking is performed in the direction toward the heart.

16. The method of claim 13, wherein the stroking is performed in a circular, clockwise direction.

17. The method of claim 13, further comprising applying oil to the body tissue.
